(19) United States
(12) Patent Application Publication
(10) Pub. No.: US 2003/0103137 A1
(43) Pub. Date: Jun. 5, 2003

(54) Test configuration for a metrological examination of a test object, in particular an integrated circuit

(76) Inventors: Klaus Espertshuber, Marklkofen (DE); Stefan Sommer, Furth (DE); Maud Prevert, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/295,685

(22) Filed: Nov. 15, 2002

(30) Foreign Application Priority Data
Nov. 15, 2001 (DE) 101 56 210.1

(51) Int. Cl. H04N 9/47

(52) U.S. Cl. 348/87; 382/128; 382/141

(57) ABSTRACT

A test configuration for the metrological examination of a test object (in particular, an integrated circuit) contains an apparatus (in the form of a microscope) for representing the test object. The apparatus generates a representation image for representing the test object. A test device (with an associated test element) taps off an electrical signal at the test object, and generates a representation image for representing the electrical signal. Another device carries out a real-time coupling of the representation image of the test device with the representation image of the apparatus. The test configuration enables the metrological examination of the test object to be carried out cost and time-effectively.

### BACKGROUND OF THE INVENTION

1. Field of the Invention

The present invention relates to a test configuration for the metrological examination of a test object (in particular, an integrated circuit). The test configuration has an apparatus for the optical representation of a test object, and a test device with an associated test element for tapping off or applying an electrical signal at the test object.

Integrated circuits are fabricated on wafers composed of semiconductor material. Each wafer (under certain circumstances) has a very large number of adjacent integrated circuits disposed in such a way that the area of the wafer is utilized as much as possible. Contact areas via which electrical signals can be transmitted from and to the respective integrated circuit are situated at the surface of each integrated circuit. The contact areas are also referred to as pads.

The contact areas are usually contact-connected to test-tips (i.e., test elements in the form of “probe needles”) of a test device for testing the integrated circuits situated on the wafer. Then, electrical signals are transmitted (via the test tips and the contact areas contact-connected thereto) from the test device to the integrated circuit and vice versa.

Due to the increasing miniaturization of integrated circuits during the metrological testing of the integrated circuits (i.e., “electrical probing”), the probe needle can generally be placed on a wafer or a semiconductor module (to be tested) only with the aid of a microscope. Consequently, there is no possibility for simultaneously observing (during probing) the electrical signal, which is tapped off from the probe needle and represented at the test device (i.e., an oscilloscope). Simultaneous observation is necessary, since, often, very small changes and movements at the probe needle cause the electrical contact to be reduced or the electrical contact to be lost.

One solution to such a problem may lie in simultaneously observing the electrical signal (by a second person). Furthermore, it is possible to make small changes and movements at the probe needle, and then to monitor the electrical signal. In other words, it is possible to interrupt the observation with the microscope for this period of time. However, the aforementioned possibilities are comparatively cost and time-intensive.

### SUMMARY OF THE INVENTION

It is accordingly an object of the invention to provide a test configuration for a metrological examination of a test object (in particular, an integrated circuit) that overcomes the hereinafore-mentioned disadvantages of the heretofore-known devices of this general type. The test configuration enables the metrological examination of the test object to be carried out (comparatively) cost and time-effectively.

With the foregoing and other objects in view, there is provided, in accordance with the invention, a test configuration having an apparatus (in the form of a microscope) for the optical representation of a test object. The apparatus generates a representation image for the optical representation of the test object.

Furthermore, the test configuration has a test device (for example, in the form of an oscilloscope) with an associated test element (in the form of a probe needle) for tapping off or applying an electrical signal at the test object. The electrical signal may be transmitted from the test element to the test device or vice versa. The test device generates a representation image for the representation or display of the electrical signal.

The test configuration also includes another device, which serves for the real-time coupling-in of the representation image of the test device with the representation image of the apparatus.

Thus, it is possible to simultaneously observe the test element (in conjunction with the test object) and the electrical signal tapped off/applied by the test element, and to react immediately to any changes. As a result, the metrological examination of the test object can be carried out comparatively cost and time-effectively.

In particular, one advantage of the invention lies in that it is possible to observe in parallel the electrical signal and the test element in conjunction with the test object. Consequently, it is not necessary for a second person to observe the electrical signal simultaneously. It is also possible to obviate the time-intensive performance of the small changes at the test element and the subsequent monitoring of the electrical signal.

The invention is generally suitable for various metrological test applications in which a test object has to be magnified or imaged in some other way for test/measurement purposes.

In accordance with another feature of the invention, the device couples the representation image of the test device optically with the representation image of the apparatus.

In accordance with a further feature of the invention, the representation image of the apparatus can be observed with an eyepiece of the apparatus. The device is configured in such a way that it projects the representation image of the test device into a beam path of the eyepiece of the apparatus.

In accordance with an added feature of the invention, the device has a screen, in the form of a thin film transistor (TFT) display, onto which the representation image of the test device is projected. An image produced on the screen is optically coupled with the representation image of the apparatus.

In accordance with an additional feature of the invention, there is provided a data processing device (unit), which is connected to the apparatus and to the test device for transmitting image signals (to generate the respective representation image). The data processing unit, the apparatus and the test device interact in such a way that the representation image of the test device and the representation image of the apparatus can be represented together on a monitor of the data processing device. The representation image of the test device and the representation image of the apparatus are preferably superposed onto one another on the monitor.

In accordance with a concomitant feature of the invention, the apparatus (in order to generate the image signals) has a video camera that records an image of the test object, which can be represented on a personal computer by a digital video card.

Other features which are considered as characteristic for the invention are set forth in the appended claims.

Although the invention is illustrated and described herein as embodied in a test configuration for a metrological examination of a test object (in particular, an integrated circuit), it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of a test configuration according to a first exemplary embodiment of the invention;

FIG. 2 is a diagrammatic illustration of the test configuration according to a second exemplary embodiment of the invention; and

FIG. 3 is an illustration of an image observed when looking into an eyepiece of the test configuration.

### DESCRIPTION OF THE PREFERRED EMBODIMENTS

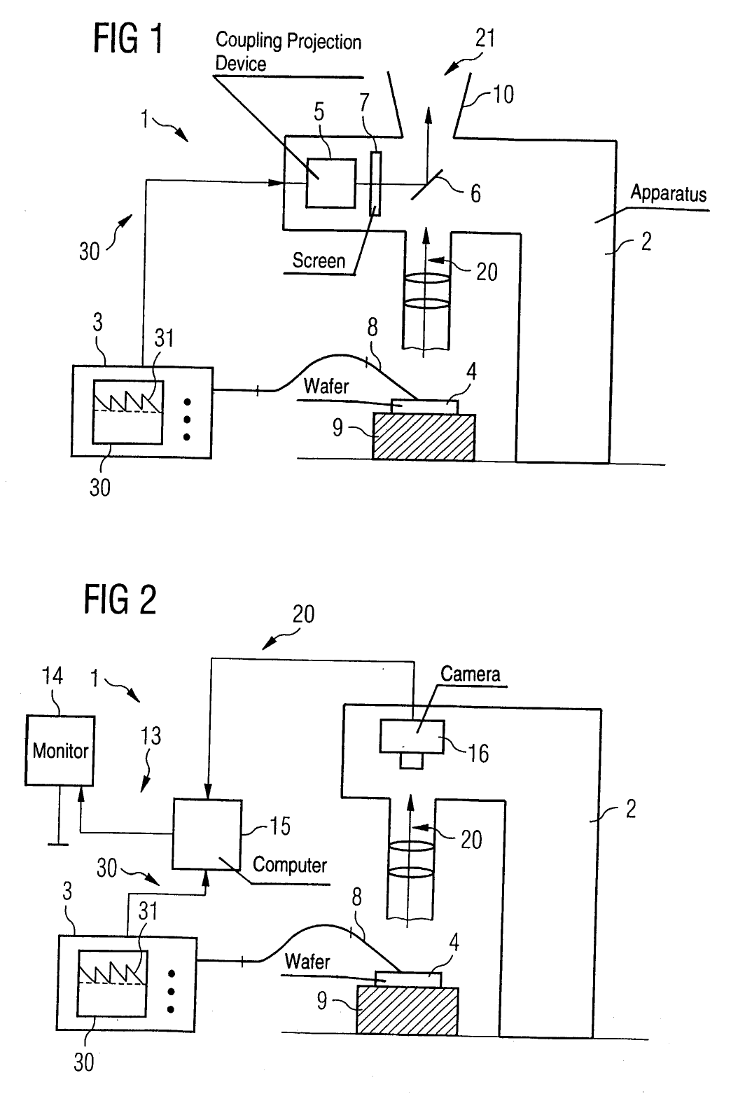

Referring now to the figures of the drawings in detail and first, particularly to FIG. 1 thereof, there is shown a test configuration 1 having a light microscope 2 and a test device 3 (in the form of an oscilloscope). A wafer 4 containing integrated circuits is disposed on a test bench 9. In order to test the integrated circuits situated on the wafer 4, corresponding contact areas are contact-connected to a test tip, in the form of a probe needle 8, which is in turn connected to the oscilloscope 3.

Further, electrical signals are transmitted from the oscilloscope 3 (via the probe needle 8 and the contact areas contact-connected thereto) to the tested integrated circuit and vice versa. The oscilloscope 3 generates a representation image 30 for the display and pictorial representation of the electrical signal 31 tapped off by the probe needle 8.

The wafer 4 (and the integrated circuits) can be observed with an eyepiece 10 of the microscope 2. A representation image for the representation of the wafer 4 is generated by the microscope in the beam path of the eyepiece 10.

Furthermore, a projection device 5, at least one prism 6, and a screen 7 are disposed in the microscope 2. The projection device 5 projects the representation image 30 of the oscilloscope 3 onto the screen 7. The screen 7 has a suitable luminous intensity and is embodied as a TFT display. The image projected onto the screen 7 is directly and optically coupled (by the prism 6) with the beam path of the eyepiece 10 (and, thus with the representation image 20 of the microscope 2, which shows the wafer 4).

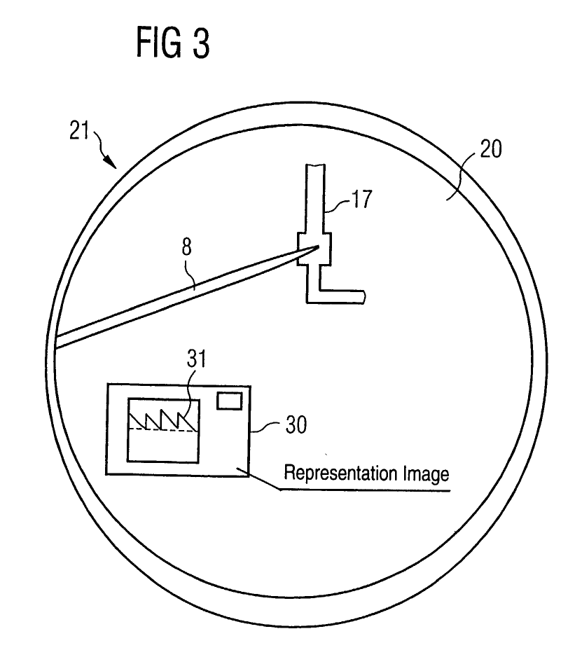

FIG. 3 shows an image 21, which can be observed when looking into the eye-piece 10 of the microscope 2 of FIG. 1. The image 21 shows a representation image 20 representing the wafer 4 or an integrated circuit disposed on the wafer 4. Interconnects 17 of the integrated circuit (to be examined) are indicated in an approximately diagrammatic manner. The probe needle 8 contacts a contact area connected to the interconnects 17.

The representation image 30 (which represents the electrical signal 31 tapped off by the probe needle 8) generated by the oscilloscope 3 is displayed at the lower part of the image 21. Further, the representation image 30 of the oscilloscope is coupled with the representation image 20 of the microscope by real-time projection.

Thus, it is thus possible to simultaneously observe (with the eyepiece of the microscope) the probe needle 8 (in conjunction with the contact area) and the electrical signal tapped off by the probe needle 8, and to immediately react to changes. The resulting advantage is that the electrical signal 31 and the probe needle 8 can be observed in parallel by a person.

FIG. 2 shows another embodiment of the test configuration according to the invention. The test configuration 1 again has a microscope 2, which serves for observing a wafer 4 disposed on a test bench 9 (or an integrated circuit disposed on the wafer). An electrical signal is tapped off by a probe needle 8, and is transmitted to an oscilloscope 3 for testing the integrated circuit.

The microscope 2 has a video camera 16 which records an image of the wafer or the integrated circuit to be observed. The image generated by the video camera 16 is transmitted to a data processing device 13 with a computer 15 in digitized format via a video card (using image signals).

The oscilloscope 3 has an image output for outputting digital image signals for transmitting the representation image 30 to the computer 15. The image signals supplied by the video camera 16 and the oscilloscope 3 are processed by the computer 15 in such a way that the representation image of the oscilloscope and the representation image of the microscope are represented (together) on the monitor 14. The images are superposed onto one another on the monitor 14. Thus, an image (corresponding to FIG. 3) is obtained on the monitor 14.

We claim:

1. A test configuration for a metrological examination of a test object, the test configuration comprising:
an apparatus for generating a representation image for optically representing the test object;
a test element coupled with said apparatus for one of tapping off and applying an electrical signal at the test object;
a test device coupled with said test element for generating a representation image for representing the electrical signal; and
a device for coupling the representation image generated by said test device with the representation image generated by said apparatus in real-time.

2. The test configuration according to claim 1, wherein said device optically couples the representation image generated by said test device with the representation image generated by said apparatus.

3. The test configuration according to claim 1, wherein:
said apparatus contains an eyepiece for observing the representation image generated by said apparatus; and
said device projects the representation image generated by said test device into a beam path of said eyepiece.

4. The test configuration according to claim 1, wherein:
said device includes a screen for projecting the representation image generated by said test device thereonto; and
an image produced on said screen is optically coupled with the representation image generated by said apparatus.

5. The test configuration according to claim 4, wherein said screen is formed with a thin film transistor (TFT) display unit.

6. The test configuration according to claim 1, further comprising:
a data processing unit having a monitor coupled with said apparatus and said test device for transmitting image signals and representing the representation images generated by said test device and said apparatus together on said monitor.

7. The test configuration according to claim 6, wherein:
said apparatus has a video camera for recording an image of the test object; and
said video camera is coupled with said data processing unit for transmitting the image signals.

8. The test configuration according to claim 7, wherein the representation image generated by said test device and the representation image generated by said apparatus are superposed onto one another on said monitor.

9. The test configuration according to claim 1, wherein said test device is configured as an oscilloscope.

10. The test configuration according to claim 1, wherein said apparatus is configured as a microscope.

11. A test configuration for a metrological examination of an integrated circuit, the test configuration comprising:
an apparatus for generating a representation image for optically representing the integrated circuit;
a test element coupled with said apparatus for one of tapping off and applying an electrical signal at the integrated circuit;
a test device coupled with said test element for generating a representation image for representing the electrical signal; and
a device for coupling the representation image generated by said test device with the representation image generated by said apparatus in real-time.
